(19) United States
(12) Patent Application Publication
(10) Pub. No.: US 2025/0199829 A1
(43) Pub. Date: Jun. 19, 2025

(54) PROMPT AUTO-GENERATION FOR AI ASSISTANT BASED ON SCREEN UNDERSTANDING

(71) Applicant: Microsoft Technology Licensing, LLC, Redmond, WA (US)

(72) Inventors: Rogerio BONATTI, Bellevue, WA (US); Justin James WAGLE, Pacifica, CA (US)

(73) Assignee: Microsoft Technology Licensing, LLC, Redmond, WA (US)

(21) Appl. No.: 18/538,694

(22) Filed: Dec. 13, 2023

(51) Int. Cl. G06F 9/451; G06V 30/19

(52) U.S. Cl. CPC G06F 9/453; G06V 30/19; G06V 2201/02

(57) ABSTRACT

Large language models (LLMs) and visual-language models (VLMs) are able to provide robust results based on specified formatting and organization. Although LLMs and VLMs are designed to receive natural language input, users often lack the skill, knowledge, or patience to utilize LLMs and VLMs to their full potential. By leveraging screen understanding, AI prompts (or “pills”) may automatically be generated for artificial-intelligence (AI) assistance and query resolution in a VLM/LLM environment. Using an image encoder, a current screenshot is processed into an image embedding and compared to text embeddings representing screenshot activities. By identifying the text embedding having the closest similarity to the image embedding, a screen activity being performed by the user may be determined. Suggested AI prompts (or “pills”) may then be generated in real-time to assist the user in performing the screen activity.

### BACKGROUND

Large language models (LLMs), or multimodal machine learning models, are able to provide powerful information retrieval for nearly any query. However, queries to LLMs are based on specified formatting and organization. Accordingly, although LLMs are designed to receive natural language input, users often lack the skill, knowledge, or patience to utilize LLMs to their full potential.

It is with respect to these and other general considerations that embodiments have been described. Also, although relatively specific problems have been discussed, it should be understood that the embodiments should not be limited to solving the specific problems identified in the background.

### SUMMARY

Aspects of the present application relate to leveraging screen understanding to automatically generate AI prompts (or “pills”) for artificial-intelligence (AI) assistance and query resolution in an LLM environment. In particular, the present application continuously captures screenshots associated with a computer display (e.g., screenshots of a foreground window). Using an image encoder, for example, a current screenshot is processed into an image embedding (e.g., image vector) representing the image content of the current screenshot. The image embedding is then compared to a plurality of text embeddings representing a plurality of screenshot activities to determine at least one text embedding having a closest similarity to the image embedding. In aspects, screenshot activities may include but are not limited to sending an email, web browsing, online shopping, listening to music, watching a video, attending a video conference, digital chatting, and the like. Based on identifying the text embedding having the closest similarity, it may be determined that the user is currently performing a screen activity corresponding to the screenshot activity represented by the text embedding. Once the screen activity is determined, suggested AI prompts (or “pills”) for an AI agent may be generated in real-time to assist the user in performing the screen activity. In other aspects, a current screenshot may be processed end-to-end by a multimodal visual-language model to generate suggested AI prompts. In this way, the present application anticipates user needs and provides tangible assistance for meeting those needs.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system according to aspects of the present disclosure.

FIGS. 2A-2E illustrate an example overview of capturing and processing a screenshot of a foreground window to determine a screen activity being performed by a user, according to aspects described herein.

FIGS. 3A-3E illustrate example overviews of automatically generating AI prompts for assisting the user in performing a screen activity, according to aspects described herein.

FIGS. 4A-4D illustrate an example AI interface for providing auto-generated AI prompts to a user, according to aspects described herein.

FIG. 5A illustrates an overview of an example method for determining AI prompts for assisting a user in performing a screen activity, according to aspects described herein.

FIG. 5B illustrates an overview of an example method for generating text embeddings representing a plurality of screenshot activities, according to aspects described herein.

FIG. 5C illustrates an overview of an example method for automatically generating AI prompts for assisting a user in performing a screen activity, according to aspects described herein.

FIG. 5D illustrates an overview of an example method for automatically generating AI prompts end-to-end for assisting a user in performing a screen activity, according to aspects described herein.

FIG. 6 is a block diagram illustrating example physical components of a computing device with which aspects of the disclosure may be practiced.

FIG. 7 is a simplified block diagram of a computing device with which aspects of the present disclosure may be practiced.

FIG. 8 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

As detailed above, aspects of the present application relate to leveraging screen understanding to automatically generate AI prompts (or “pills”) for artificial-intelligence (AI) assistance and query resolution in an LLM environment. As described above, the present application continuously captures screenshots associated with a computer display (e.g., screenshots of a foreground window). Using an image encoder, for example, a current screenshot is processed into an image embedding (e.g., image vector) representing the image content of the current screenshot. The image embedding is then compared to a plurality of text embeddings representing a plurality of screenshot activities to determine at least one text embedding having a closest similarity to the image embedding. For example, a zero-shot classifier may be utilized to calculate the similarity between the image vector (e.g., image embedding) representing the current screenshot and semantic vectors (e.g., text embeddings) representing each of the plurality of screenshot activities. Based on identifying the text embedding having the closest similarity, it may be determined that the user is currently performing the screenshot activity represented by the text embedding. In aspects, the screenshot activity can be determined without extracting any textual information from the current screenshot, enabling the screenshot activity to be determined whether or not text is blurred or otherwise illegible for purposes of character recognition over the current screenshot.

In some cases, once the screenshot activity is determined, the current screenshot may be processed to detect textual information (e.g., using an optical character recognition (OCR) model). Based on the textual information extracted from the current screenshot, one or more topics associated with the screenshot activity may be determined. For example, the textual information may be evaluated to extract terms, which in some cases may be scored for relevancy to determine a top subset of topics (e.g., top-K topics) associated with the screenshot activity. Once the screenshot activity and/or topics are determined, suggested AI prompts (or “pills”) for an AI agent may be generated in real-time to assist the user in performing the screen activity. In some examples, the AI prompts may be selected from a plurality of predefined AI prompts associated with the screen activity. In other examples, to generate more targeted AI prompts, AI prompt generation may take into consideration topics associated with the screen activity. In this case, AI prompts may be automatically generated by customizing a predefined AI prompt or by implementing an LLM instructed to consider the determined screen activity and topics. In other aspects, a current screenshot may be processed end-to-end by a multimodal visual-language model to generate suggested AI prompts. In this way, AI prompts may be provided in near real-time to assist the user in performing the screen activity, which not only facilitates performing the current screen activity but fosters user engagement with the AI assistant for this and future screen activities.

In examples, a generative model (also generally referred to herein as a type of machine learning (ML) model) may be used according to aspects described herein and may generate any of a variety of output types (and may thus be a multimodal generative model, in some examples). For example, the generative model may include a generative transformer model and/or a large language model (LLM), a generative image model, or the like. Example ML models include, but are not limited to, Megatron-Turing Natural Language Generation model (MT-NLG), Generative Pre-trained Transformer 3 (GPT-3), Generative Pre-trained Transformer 4 (GPT-4), BigScience BLOOM (Large Open-science Open-access Multilingual Language Model), DALL-E, DALL-E 2, Stable Diffusion, or Jukebox.

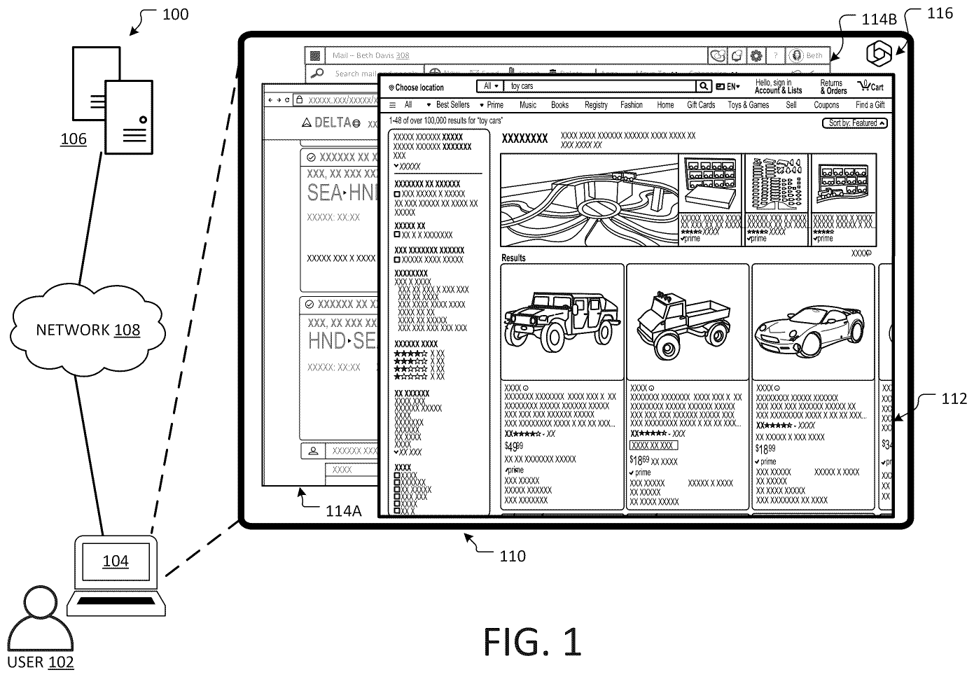

FIG. 1 illustrates an overview of an example system 100 according to aspects of the present disclosure.

As illustrated, system 100 includes user 102, computing device 104, server(s) 106, and network 108. In examples, user 102 interacts with computing device 104, which communicates with server 106 via network 108. User 102 may interact with applications, websites, browsers, apps, plugins, and the like, to perform various activities using computing device 104. In some aspects, computing device 104 may provide one or more windows of a display interface 110, where each window may be associated with at least one activity being performed by the user 102. In aspects, a foreground window (e.g., foreground window 112) may be associated with a window in a forward position, which may overlap other windows but is not overlapped by other windows; whereas a background window (e.g., background windows 114A-B) is in a backward position overlapped by one or more other windows. In some aspects, a display interface may comprise one or more foreground windows and zero, one, or more background windows.

In examples, an activity being performed by user 102 in a window of the display interface 110 may be referred to herein as a “screen activity.” A screen activity may include but is not limited to “sending an email,” “web browsing,” “online shopping,” “listening to music,” “watching a video,” “attending a video conference,” “digital chatting,” and the like. In aspects, a screen activity may be performed using any application, website, browser, app, plugin, and the like, running on or accessible to computing device 104, e.g., via network 108. Network 108 may comprise a local area network, a wireless network, or the Internet, or any combination thereof, among other examples.

As illustrated, user 102 is performing a screen activity associated with online shopping in foreground window 112. In aspects, while background window 114A illustrates a screen activity associated with booking a flight and background window 114B illustrates a screen activity associated with sending email, the user 102 may not be currently performing these screen activities associated with the background windows 114A-B. In this case, whereas a real-time AI prompt may be beneficial for accomplishing the screen activity that is the focus of user 102 in the foreground window 112, real-time AI prompts for accomplishing background activities would likely go unnoticed.

In aspects, screenshots associated with display interface 110 may be continuously captured and analyzed. For example, screen-based raw data and metadata may be collected and recorded every few seconds (e.g., 2 seconds) for one or more windows associated with display interface 110. Captured screenshots may be processed using one or more machine learning (ML) models, in some cases running locally on neural processing units (NPUs), to identify a plurality of screenshot activities. As used herein, a “screenshot activity” corresponds to a captured image of a “screen activity.” Thus, a screenshot activity may include but is not limited to a captured image of sending an email, web browsing, online shopping, listening to music, watching a video, attending a video conference, digital chatting, and the like.

Once screenshot activities are identified, textual descriptions of each screenshot activity may be generated. For example, for a screenshot activity of “writing an email,” textual descriptions may include without limitation, “writing an email,” “writing an email in Gmail,” “writing an email in Outlook,” “writing an email in Yahoo,” and the like. In some aspects, one or more ML models, such as a large language model (LLM), may be utilized to generate the textual descriptions of each screenshot activity.

In some examples, an inclusion list and/or an exclusion list may be defined for a screenshot activity. An inclusion list may entail one or more applications or one or more uniform resource locators (URLs) that may be associated with performing a screenshot activity; whereas an exclusion list may entail one or more applications or one or more URLs that are not associated with performing the screenshot activity. For example, for a screenshot activity of “writing an email,” an exclusion list may entail applications such as “Microsoft® Word®,” “Microsoft® Excel®,” and “Microsoft® PowerPoint®.” In contrast, an inclusion list may entail applications such as “Google® Chrome®,” “Microsoft® Edge®,” “Mozilla® Firefox®,” “Microsoft® Outlook®,” and “Mozilla Thunderbird®,” and/or URLs such as “mail.google.com,” “outlook.live.com,” and “mail.yahoo.com.” In aspects, an inclusion list and/or an exclusion list may be included in the textual descriptions of the screenshot activity.

The textual descriptions for each screenshot activity may then be processed into text embeddings. For example, a text encoder (e.g., an ML model trained to process text content) may process the textual descriptions for each screenshot activity into a text embedding. Each text embedding (e.g., semantic vector) may include a plurality of dimensions uniquely representing the textual descriptions of a screenshot activity. In some aspects, the text embeddings for the plurality of screenshot activities may be stored. In this way, rather than utilizing time and resources to generate the text embeddings in real-time, they may be stored and retrieved when needed.

In contrast, a current screenshot of a foreground window (e.g., foreground window 112) may be captured and processed in real-time into an image embedding using an image encoder (e.g., an ML model trained to process image content). The image embedding (e.g., image vector) may include a plurality of dimensions uniquely representing the image content of the current screenshot. The image embedding of the current screenshot may then be compared to each text embedding of the plurality of text embeddings to determine at least one text embedding having a closest similarity to the image embedding. For example, a zero-shot classifier may be utilized to calculate the similarity between the image vector representing the current screenshot and semantic vectors (e.g., text embeddings) representing each of the plurality of screenshot activities.

Based on identifying a text embedding having the closest similarity, it may be determined that the user is currently performing a screen activity corresponding to the screenshot activity represented by the text embedding. Once the screen activity is determined, suggested AI prompts (or “pills”) for an AI agent may be generated in real-time to assist the user 102 in performing the screen activity.

In some cases, to generate more targeted AI prompts, the image information of the current screenshot may be processed to detect textual information (e.g., using an optical character recognition (OCR) model). As should be appreciated, any model for detecting and/or extracting textual information from the current screenshot may be utilized, whether running locally or on a remote server system or cloud computing environment. Based on the textual information extracted from the current screenshot, one or more topics associated with the screen activity may be determined. For example, the textual information may be evaluated to extract terms, which in some cases may be scored for relevancy based on a number of times the terms appear, where the terms appear (e.g., header, subject line, body, etc.), and the like. Based on the scoring, a top subset of topics (e.g., top-K topics) associated with the screen activity may be determined. For example, for an online shopping activity, ranked terms such as “toy,” “car,” “truck,” “RC,” “boys,” may be associated with top-K topics including, “toy car,” “toy truck,” “toys for boys,” “remote control toys,” and the like.

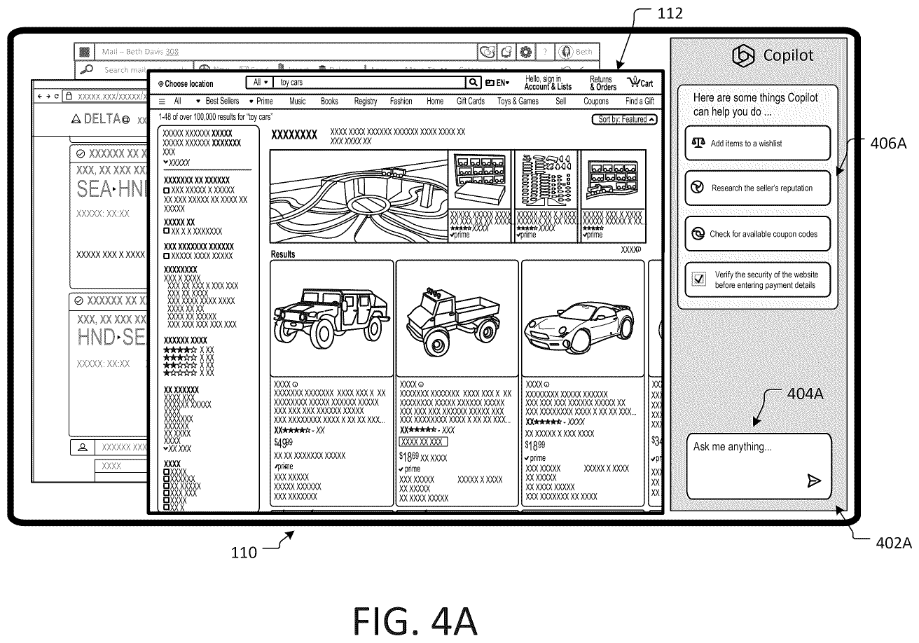

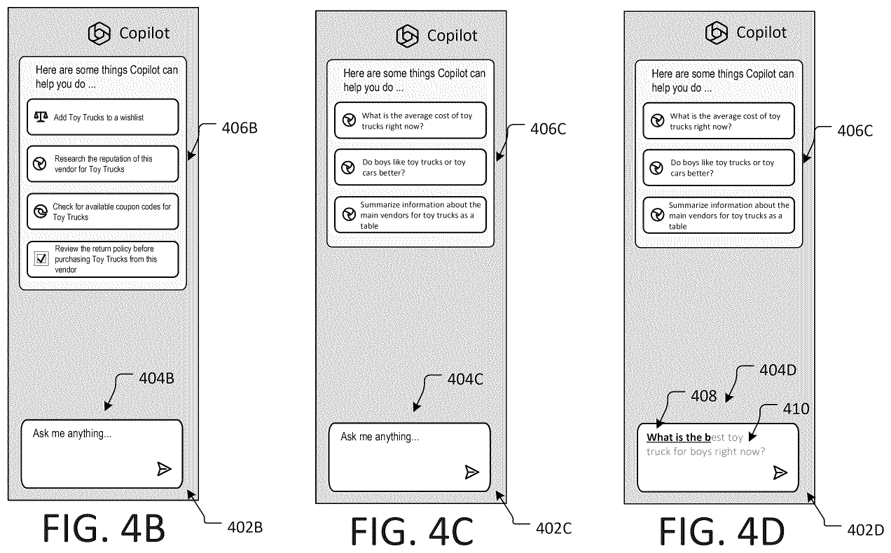

In combination with the screen activity, the top-K topics may be used to generate more targeted AI prompts (or “pills”) to assist the user 102 in performing the screen activity. For example, based on the screen activity and one or more topics, a large language model (LLM) may be used to generate the suggested AI prompts. In some cases, when one or more AI prompts are generated, an AI interface (FIGS. 4A-4D) may be opened for selectively initiating with an AI agent. For example, the AI interface may popup, dropdown, slide over, or the like. Additionally or alternatively, icon 116 may be activated to open the AI interface. Thus, based on screen understanding, the system may proactively anticipate the user's needs and provide a well-formed AI prompt to an AI agent for assisting the user in performing the screen activity.

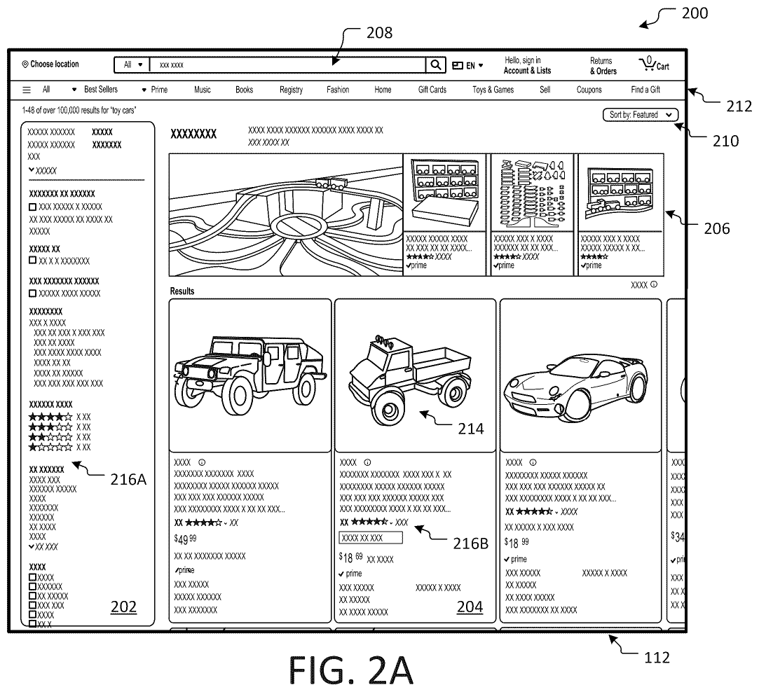

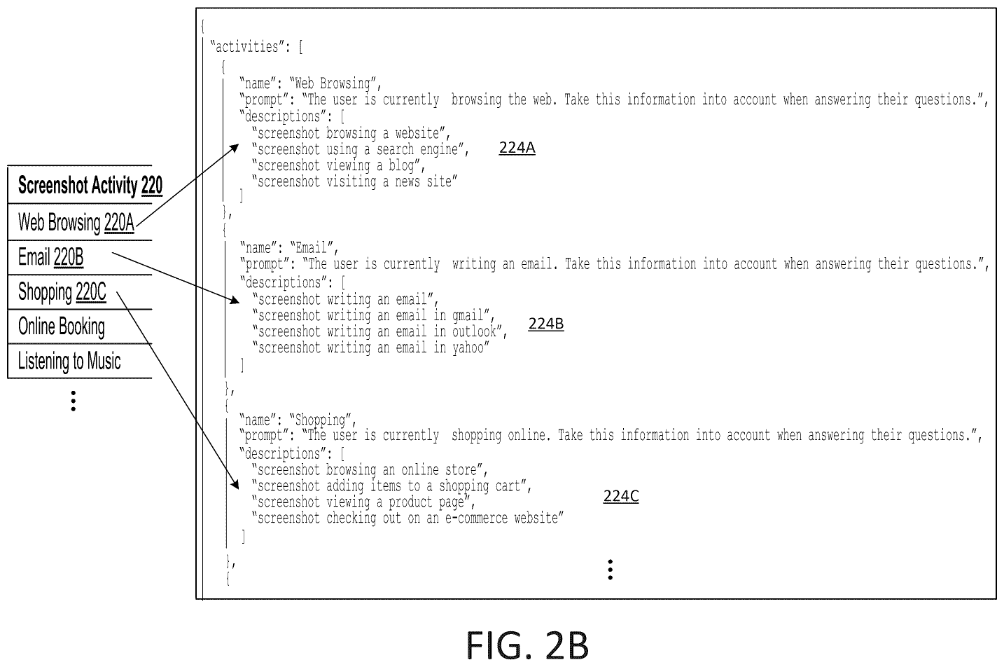

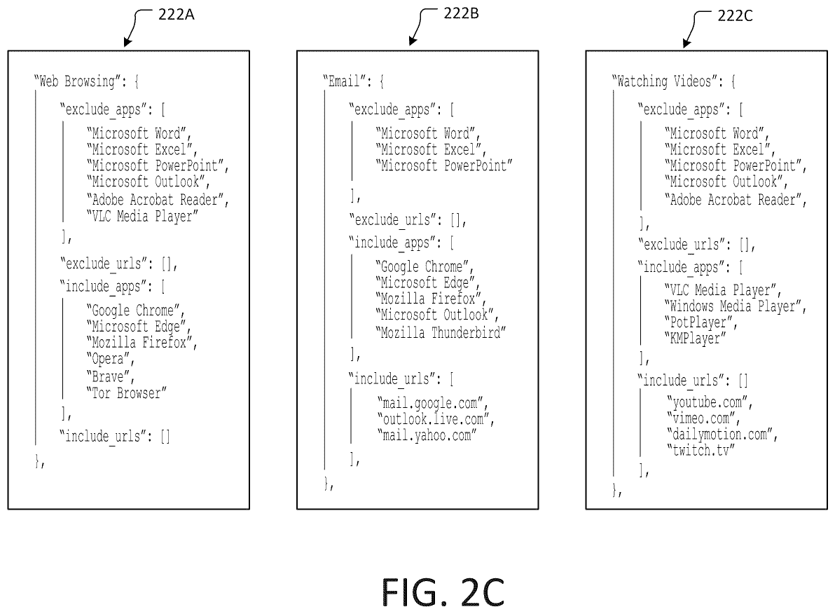

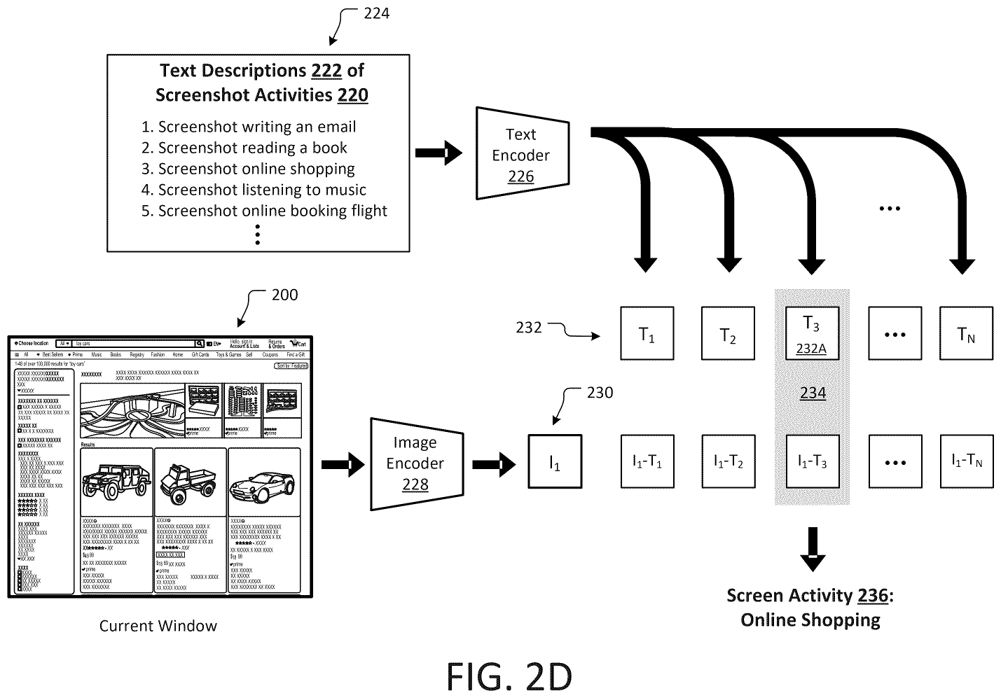

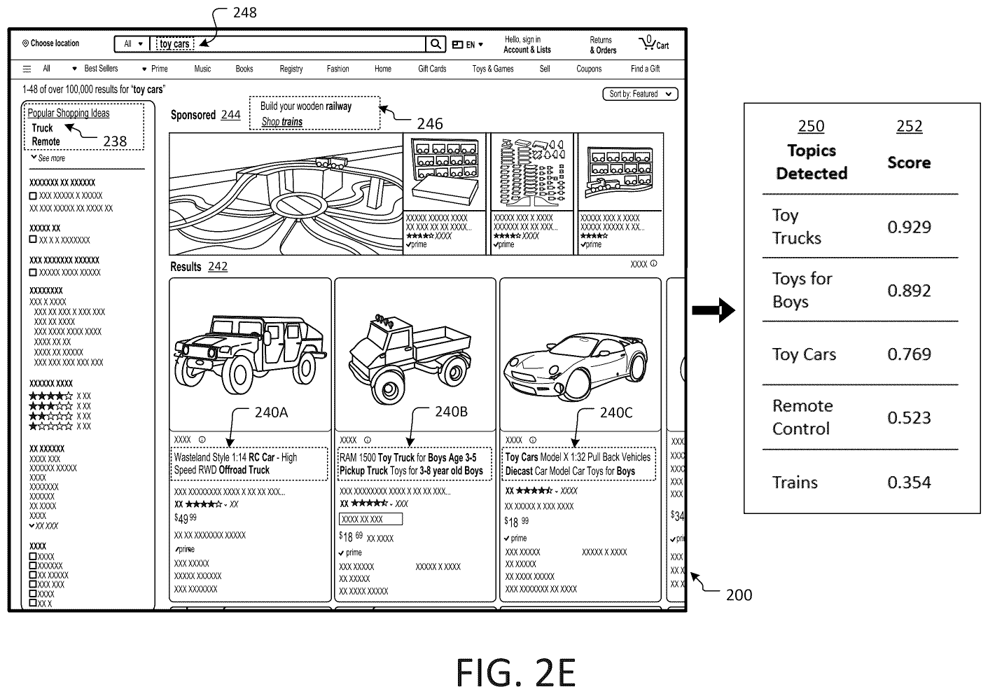

FIGS. 2A-2E illustrate examples of capturing and processing a screenshot of a foreground window to determine a screen activity being performed by a user, according to aspects described herein.

FIG. 2A illustrates a current screenshot 200 captured of foreground window 112 (FIG. 1). While the text associated with foreground window 112 is largely illegible in the current screenshot 200, other features include images, boxes, buttons, fields, banners, ribbons, graphics, and the like. For example, sidebar 202 includes what appears to be a column of illegible text 216A with various formatting (e.g., italics, bolding, indentation) and graphics (e.g., stars, boxes). Vertical box 204 includes image 214 above illegible text 216B (with various formatting and graphics). Similarly, horizontal banner 206 includes multiple boxes with images provided over illegible text. The current screenshot 200 further includes a field 208, button 210 and ribbon 212. In some cases, although the text is largely illegible in current screenshot 200, other visual features may be evaluated to determine the application, URL, website, etc., running in foreground window 112 and ultimately, the screenshot activity being performed by the user.

FIG. 2B illustrates example textual descriptions for various screenshot activities 220 that may be performed. As described above, the system may continuously capture screenshots of computer displays and the captured screenshots may be processed using one or more machine learning (ML) models to identify a plurality of screenshot activities 220. Once screenshot activities 220 are identified, textual descriptions of each screenshot activity may be generated. In some aspects, one or more ML models, such as a large language model (LLM), may be utilized to generate the textual descriptions of each screenshot activity 220.

As illustrated, for a screenshot activity of web browsing 220A, non-limiting examples of textual descriptions 224A include “screenshot browsing a website,” “screenshot using a search engine,” “screenshot viewing a blog,” and “screenshot visiting a news site.” For a screenshot activity of email 220B, textual descriptions 224B include without limitation, “screenshot writing an email,” “screenshot writing an email in gmail,” “screenshot writing an email in outlook,” and “screenshot writing an email in yahoo.” For a screenshot activity of shopping 220C, non-limiting examples of textual descriptions 224C include, “screenshot browsing an online store,” “screenshot adding items to a shopping cart,” “screenshot viewing a product page,” and “screenshot checking out an e-commerce website.”

FIG. 2C illustrates example inclusion/exclusion lists 222A-C defined for screenshot activities 220. As noted above, an inclusion list may entail one or more applications or one or more uniform resource locators (URLs) that may be associated with performing a screenshot activity; whereas an exclusion list may entail one or more applications or one or more URLs that are not associated with performing the screenshot activity. While illustrated as combined inclusion/exclusion lists 222A-C, an inclusion list may be provided independently from an exclusion list, only an inclusion list or an exclusion list may be provided, or neither list may be provided. In some cases, an exclusion list, i.e., which specifies apps and URLs that are not associated with performing a screenshot activity, may be more useful for preventing false positives when determining a screen activity associated with a current screenshot (e.g., current screenshot 200).

As illustrated, in non-limiting examples, inclusion/exclusion list 222A for a screenshot activity of web browsing excludes apps “Microsoft Word,” “Microsoft Excel,” “Microsoft PowerPoint,” “Microsoft Outlook,” “Adobe Acrobat Reader,” and “VLC Media Player”; while including apps “Google Chrome,” “Microsoft Edge,” “Mozilla Firefox,” “Opera,” “Brave,” and “Tor Browser.” Inclusion/exclusion list 222B for a screenshot activity of email, in non-limiting examples, excludes apps “Microsoft Word,” “Microsoft Excel,” and “Microsoft PowerPoint”; while including apps “Google Chrome,” “Microsoft Edge,” “Mozilla Firefox,” “Microsoft Outlook,” and “Mozilla Thunderbird.” Inclusion/exclusion list 222B further includes URLs “mail.google.com,” “outlook.live.com,” and “mail.yahoo.com.” In non-limiting examples, inclusion/exclusion list 222C for a screenshot activity of watching videos excludes apps “Microsoft Word,” “Microsoft Excel,” “Microsoft PowerPoint,” “Microsoft Outlook,” and “Adobe Acrobat Reader”; while including apps “VLC Media Player,” “Windows Media Player,” “PotPlayer,” and “KMPlayer.” Inclusion/exclusion list 222C further includes URLs “youtube.com,” “vimeo.com,” “dailymotion.com,” and “twitch.tv,” for example.

FIG. 2D illustrates performing a comparison of text embeddings 232 for a plurality of screenshot activities 220 to an image embedding 230 of a current screenshot (e.g., current screenshot 200). As described above, textual descriptions 222 of screenshot activities 220 may be processed by text encoder 226 to generate text embeddings 232 of the screenshot activities 220. The image embedding 230 of the current screenshot 200 may be compared to each of the text embeddings 232 to detect a text embedding 232A (e.g., T3) having a closest similarity (e.g., match 234) to the image embedding 230. For example, a zero-shot classifier may be utilized to calculate the similarity between the image vector representing the current screenshot 200 and the text embeddings 232 representing each of the plurality of screenshot activities 220. In aspects, a zero-shot classifier need not be retrained if more or fewer classes of screenshot activities are defined.

Upon determining that text embedding 232A (e.g., T3) has the closest similarity to the image embedding 230, it may be determined that the user is performing a screen activity 236 corresponding to the screenshot activity 220 represented by text embedding 232A. As illustrated, it has been determined that the user is performing a screen activity 236 of “online shopping” in the foreground window (e.g., foreground window 112) captured in current screenshot 200.

Further, according to aspects described herein, determining the at least one text embedding 232 (e.g., T3) having the closest similarity to the image embedding 230 may be performed without extracting text information from the current screenshot 200. That is, the methods and systems for determining a screen activity are performed on the image content of the current screenshot and are successful even when text associated with the current screenshot is blurred or otherwise illegible.

FIG. 2E illustrates topic discovery based on the current screenshot 200 captured of foreground window 112 (FIG. 1). As described above, once a screen activity 236 (FIG. 2D) is determined, the image information of the current screenshot 200 may be processed to detect textual information (e.g., using an optical character recognition (OCR) model). Based on the textual information extracted from the current screenshot 200, one or more topics 250 associated with the screen activity 236 may be determined. For example, the textual information may be evaluated to extract terms, which in some cases may be scored 252 for relevancy based on a number of times the terms appear, where the terms appear (e.g., header, subject line, body, etc.), and the like. Based on the scoring 252, a top subset of topics (e.g., top-K topics) associated with the screen activity 236 may be determined.

For example, the current screenshot 200 may be scanned and terms may be extracted from various areas of the captured image. For example, terms “Truck” and “Remote” may be extracted from area 238 (e.g., “popular shopping ideas”) and terms “RC Car,” “Offroad Truck,” “Toy Truck,” “Pickup Truck,” “Boys,” “Age 3-5,” “3-8 year old Boys,” “Toy cars,” “Diecast,” and “Boys” may be extracted from areas 240A-C (e.g., text associated with results 408). Further, terms “railway” and “trains” may be extracted from area 246 (associated with sponsored results 244) and “toy cars” from search field area 248. In some cases, terms extracted from some areas of the current screenshot 200 may be given greater weight than others. For example, terms extracted from a results area 242 may be given greater weight than terms extracted from a sponsored results area 244 and terms extracted from search field area 248 may be given greater weight than other areas.

As further illustrated by FIG. 2E, topics 250 may be determined from the extracted terms and scores 252 may be assigned to the topics 250 based on statistical relevance. Based on the scoring 252, non-limiting examples of the top-K topics for the current screenshot 200 include, “Toy Trucks” (0.929), “Toys for Boys” (0.892), “Toy Cars” (0.769), “Remote Control Toys” (0.523), and “Trains” (0.354).

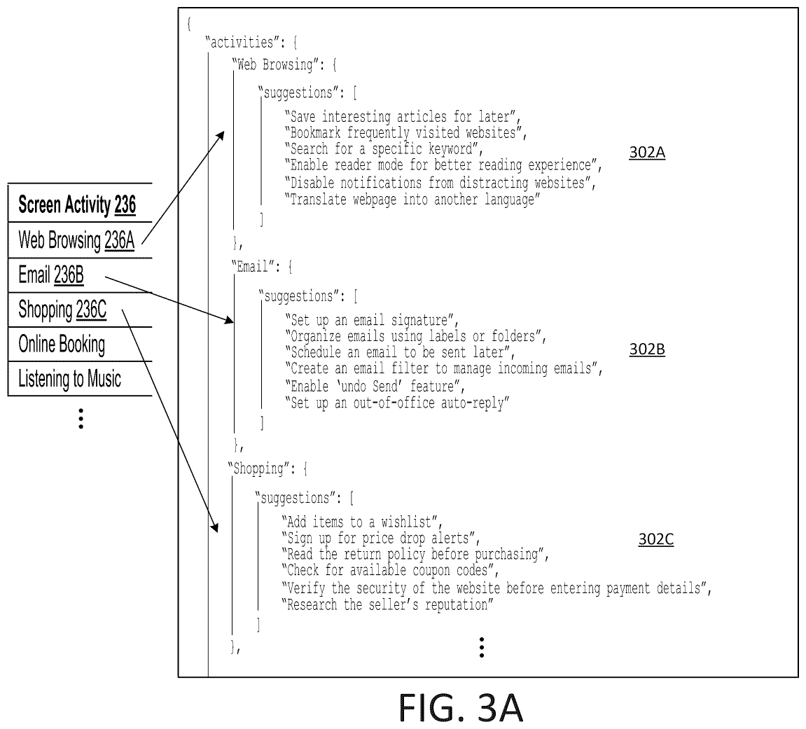

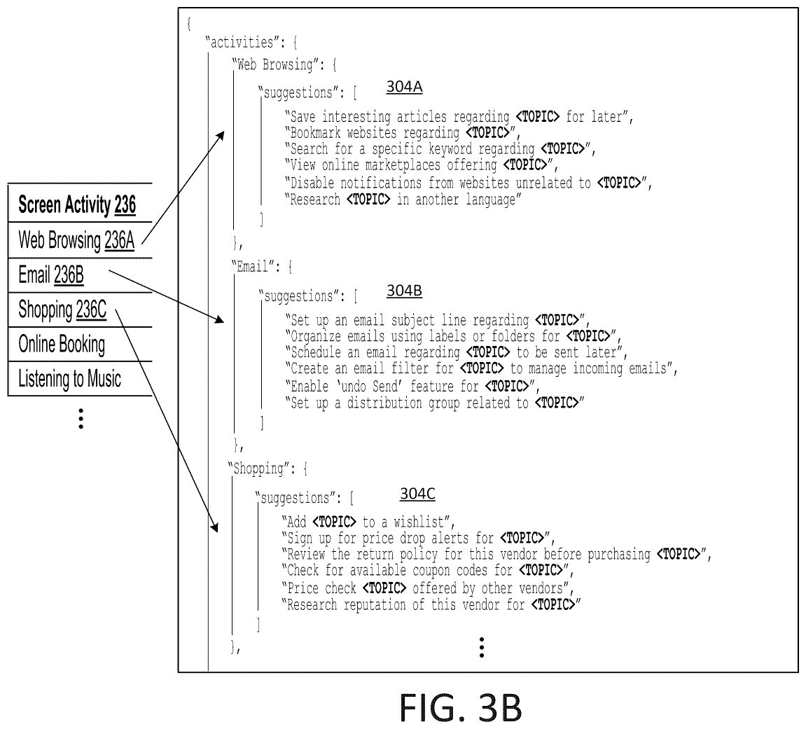

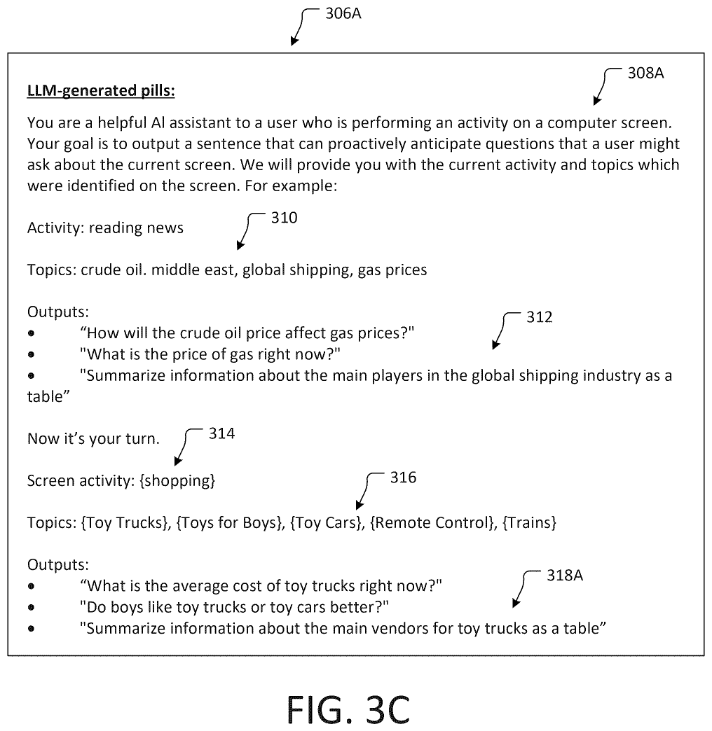

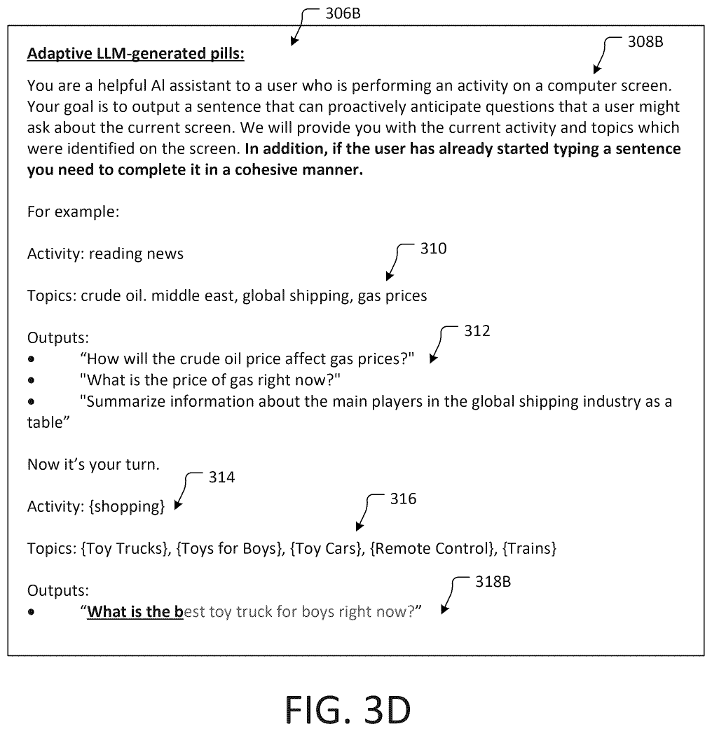

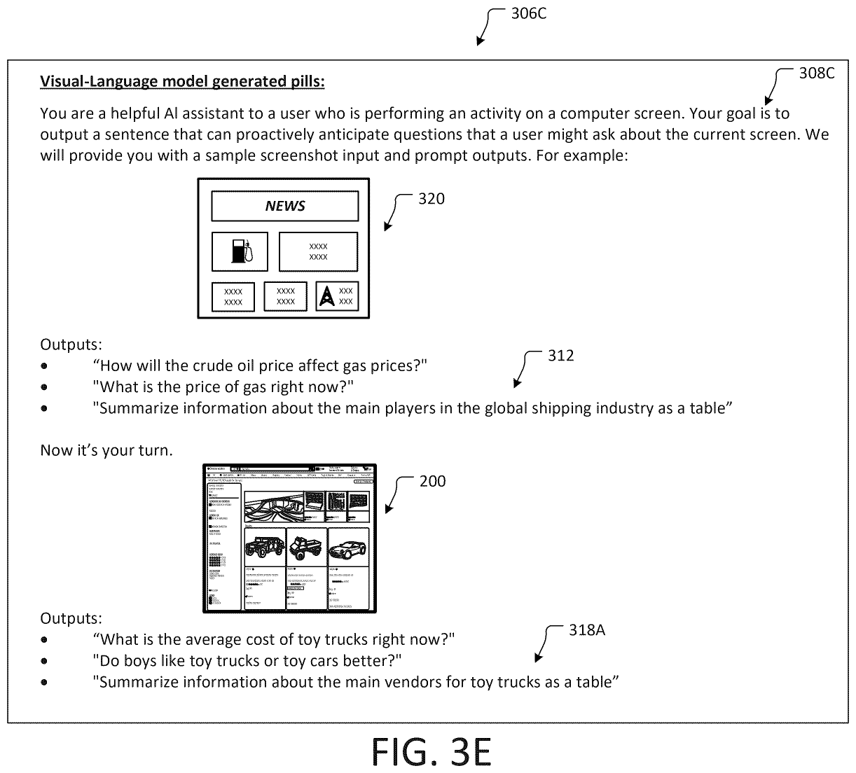

FIGS. 3A-3D illustrate an example overview of automatically generating AI prompts for assisting the user in performing a determined screen activity, according to aspects described herein.

FIG. 3A illustrates example AI prompt suggestions that may be predefined for screen activities 236. As noted above, users often lack experience with properly forming AI prompts (or pills) to an AI agent. In this case, a plurality of AI prompts may be predefined for each screen activity 236. Then, when it is determined that the user is performing the screen activity 236, one or more AI prompts may be selected from the plurality of predefined AI prompts and provided to the user (e.g., via an AI interface). In this way, AI prompts may be provided in near real-time to assist the user in performing the screen activity 236, which not only facilitates performing the current screen activity 236 but fosters user engagement with the AI assistant for this and future screen activities. While this method offers a highly responsive solution, the predefined AI prompts may be limited in their ability to adapt to more specific needs of the user.

As illustrated, for a screen activity of web browsing 236A, non-limiting examples of preformed AI prompt suggestions 302A include, “Save interesting articles for later,” “Bookmark frequently visited websites,” “Search for a specific keyword,” “Enable reader mode for better reading experience,” “Disable notifications from distracting websites,” and “Translate webpage into another language.”

For a screen activity of email 236B, non-limiting examples of preformed AI prompt suggestions 302B include, “Set up an email signature,” “Organize emails using labels or folders,” “Scheduling an email to be sent later,” “Create an email filter to manage incoming emails,” “Enable ‘undo send’ feature,” and “Set up an out-of-office auto-reply.”

For a screen activity of shopping 236C, non-limiting examples of preformed AI prompt suggestions 302C include, “Add items to a wishlist,” “Sign up for price drop alerts,” “Read the return policy before purchasing,” “Check for available coupon codes,” “Verify the security of the website before entering payment details,” and “Research the seller's reputation.”

FIG. 3B illustrates example AI prompt suggestions including topic placeholders that may be predefined for screen activities 236. In some aspects, after determining a screen activity, topic discovery may be performed on a current screenshot to determine one or more topics associated with the determined screen activity. In this case, a plurality of AI prompts may be predefined for each screen activity but may be customizable based on the one or more topics. To generate an AI prompt at runtime, a topic (e.g., top topic) is used to replace the topic placeholder in the predefined AI prompt. In this way, the AI prompt is more specific to the screen activity at hand, while also enabling responsive, real-time AI support to the user. In some examples, replacing the topic placeholder in the predefined AI prompt with a topic may result in a non-sensical AI prompt. To avoid a poor user experience, the generated AI prompt may be examined for semantic and grammatical coherence before providing the AI prompt to the user (e.g., via an AI interface).

As illustrated, for a screen activity of web browsing 236A, non-limiting examples of preformed AI prompt suggestions including topic placeholders 304A include, “Save interesting articles regarding <TOPIC> for later,” “Bookmark websites regarding <TOPIC>,” “Search for a specific keyword regarding <TOPIC>,” “View online marketplace offering <TOPIC>,” “Disable notifications from websites unrelated to <TOPIC>,” and “Research <TOPIC> in another language.”

For a screen activity of email 236B, non-limiting examples of preformed AI prompt suggestions including topic placeholders 304B include, “set up an email subject line regarding <TOPIC>,” “organize emails using labels or folders for <TOPIC>,” “schedule an email regarding <TOPIC> to be sent later,” “create an email filter for <TOPIC> to manage incoming emails,” “enable ‘undo send’ feature for <TOPIC>,” and “set up a distribution group related to <TOPIC>.”

For a screen activity of shopping 236C, non-limiting examples of preformed AI prompt suggestions including topic placeholders 304C include, “Add <TOPIC> to a wishlist,” “Sign up for price drop alerts for <TOPIC>,” “Read the return policy for this vendor before purchasing <TOPIC>,” “Check for available coupon codes for <TOPIC>,” “Price check <TOPIC> offered by other vendors,” and “Research the reputation of this vendor for <TOPIC>.”

FIG. 3C illustrates an example LLM prompt 306A for generating AI prompts (or pills) for an AI agent. In this case, a well-formed AI prompt (or pill) may be generated which can adapt to the user's screen activity with more confidence, for example, than a predefined AI prompt. In some cases, running the LLM may cause latencies not experienced when selecting a predefined AI prompt. However, the benefits of generating real-time AI prompts may outweigh latency concerns, which may also be improved by running a local LLM on a neural processing unit (NPU).

As illustrated, LLM prompt 306A includes chain-of-thought LLM instructions 308A, example inputs 310 (e.g., example activity of “reading news” and example topics of “crude oil,” “middle east,” “global shipping,” “gas prices”), and example outputs 312 (e.g., example AI prompts including, “How will the crude oil price effect gas prices?”; “What is the price of gas right now?”; “Summarize information about the main players in the global shipping industry as a table”). Based on the LLM instructions 308A and the example inputs 310 and outputs 312, the LLM is able to receive a current activity input 314 (see, e.g., FIG. 2D, “shopping”) and current topic inputs 316 (see, e.g., FIG. 2E, “toy trucks,” “toys for boys,” “toy cars,” “remote control,” “trains”) from other models to generate AI prompts 318A including, “What is the average cost of toy trucks right now?”; “Do boys like toy trucks or toy cars better?”; and “Summarize information about the main vendors for toy trucks as a table.”

FIG. 3D illustrates an example LLM prompt 306B for adaptively generating AI prompts (or pills) for an AI agent. In this case, the LLM may be run in a loop to auto-complete partial user input. In this way, the AI prompt is adaptive to the user's input. However, as noted above, running the LLM may cause latencies not experienced when selecting or customizing a predefined AI prompt. Even so, the benefits of generating adaptive, real-time AI prompts may outweigh latency concerns, which may also be improved by running a local LLM on a neural processing unit (NPU).

As illustrated, LLM prompt 306B includes chain-of-thought LLM instructions 308B (which includes additional instructions for completing a partial user input in a cohesive manner), example inputs 310 (e.g., example activity of “reading news” and example topics of “crude oil,” “middle east,” “global shipping,” “gas prices”), and example outputs 312 (e.g., example AI prompts, including “How will the crude oil price effect gas prices?”; “What is the price of gas right now?”; “Summarize information about the main players in the global shipping industry as a table”). Based on the LLM instructions 308B and the example inputs 310 and outputs 312, the LLM is able to receive a current activity input 314 (see, e.g., FIG. 2D, “shopping”) and current topic inputs 316 (see, e.g., FIG. 2E, “toy trucks,” “toys for boys,” “toy cars,” “remote control,” “trains”) from other models to complete a partial user input of “What is the b . . . ” to generate AI prompt 318B including, “What is the best toy truck for boys right now?”

FIG. 3E illustrates an example visual-language model (VLM) prompt 306C for generating AI prompts (or pills) for an AI agent. In this case, a well-formed AI prompt (or pill) may be generated end-to-end using a multi-modal visual-language model (VLM). Similar to the examples described with respect to FIGS. 3C-3D, VLM-generated AI prompts can adapt to the user's screen activity with more confidence, for example, than a predefined AI prompt (see, e.g., FIGS. 3A-3B). In some cases, running the VLM may cause latencies not experienced when selecting a predefined AI prompt. However, the benefits of generating real-time AI prompts may outweigh latency concerns, which may also be improved by running a local VLM on a neural processing unit (NPU).

As illustrated, VLM prompt 306C includes chain-of-thought VLM instructions 308C (including additional instructions for the VLM to generate AI prompts from a screenshot), example input 320 (e.g., a sample news screenshot related to oil and gas), and example outputs 312 (e.g., example AI prompts, including “How will the crude oil price effect gas prices?”; “What is the price of gas right now?”; “Summarize information about the main players in the global shipping industry as a table”). Based on the VLM instructions 308C, example input 320 and outputs 312, the VLM is able to receive the current screenshot 200 (see, e.g., FIG. 2A) to directly generate the AI prompts 318A (see, e.g., FIG. 3C) in an end-to-end fashion (e.g., without input from other models), including “What is the average cost of toy trucks right now?” “Do boys like toy trucks or toy cars better?” and “Summarize information about the main vendors for toy trucks as a table.”

FIGS. 4A-4D illustrate example AI interfaces for providing auto-generated AI prompts to a user, according to aspects described herein.

FIG. 4A illustrates display interface 110 (FIG. 1) including foreground window 112, additionally including AI interface 402A. In aspects, AI interface 402A may be in the form of a sidebar that may popup, dropdown, slide open, or otherwise, upon initiating an icon (e.g., icon 116 of FIG. 1). Additionally or alternatively, AI interface 402A may open in response to auto-generating one or more AI prompts for assisting the user in performing a screen activity. As illustrated, AI interface 402A includes input field 404A for receiving user input to an AI agent and AI prompts 406A, which may be selectable to initiate an interaction with an AI agent.

With reference to the FIGS. 2D and 3A, in response to determining that the screen activity of online shopping 236C is being performed in foreground window 112 (FIG. 2D), one or more predefined AI prompts 302A may be selected (FIG. 3A) and provided to the user via AI interface 402A. In some aspects, a subset of predefined AI prompts 302A may be displayed as AI prompts 406A via AI interface 402A. The subset of AI prompts may be determined by any suitable means, e.g., based on a relevancy ranking of the AI prompts. As illustrated, AI prompts 406A include but are not limited to “Add items to a wishlist,” “Research the seller's reputation,” “Check for available coupon codes,” and “Verify the security of the website before entering payment details.”

FIG. 4B illustrates AI interface 402B. Similar to AI interface 402A, AI interface 402B includes input field 404B for receiving user input to an AI agent and AI prompts 406B, which may be selectable to initiate an interaction with an AI agent. With reference to FIGS. 2D, 2E and 3B, in response to determining that the screen activity of online shopping 236C is being performed in foreground window 112 (FIG. 2D) and identifying top topic “toy trucks” based on topic discovery of current screenshot 200 (FIG. 2E), one or more predefined AI prompts having topic placeholders 304A may be selected (FIG. 3B). In response to replacing a topic placeholder with top topic “toy trucks,” AI prompts 406B include but are not limited to “Add toy trucks to a wishlist,” “Research the reputation of this vendor for toy trucks,” “Check for available coupon codes for toy trucks,” and “Review the return policy before purchasing toy trucks from this vendor.”

FIG. 4C illustrates AI interface 402C. Similar to AI interfaces 402A and 402B, AI interface 402C includes input field 404C and AI prompts 406C, which may be selectable to initiate an interaction with an AI agent. With reference to FIGS. 2D, 2E and 3C, in response to determining that the screen activity of online shopping 236C is being performed in foreground window 112 (FIG. 2D) and identifying top topic “toy trucks” based on topic discovery of current screenshot 200 (FIG. 2E), an LLM may be implemented to automatically generate AI prompts 406C (FIG. 3C). AI prompts 406C output by the LLM include but are not limited to “What is the average cost of toy trucks right now?” “Do boys like toy trucks or toy cars better?” and “Summarize information about the main vendors for toy trucks as a table.”

FIG. 4D illustrates AI interface 402D. Similar to AI interfaces 402A-C, AI interface 402D includes input field 404D and AI prompts 406C, which may be selectable to initiate an interaction with an AI agent. In this case, the user has entered partial input 408, “What is the b . . . ” into input field 404D. With reference to FIGS. 2D-E and 3D-E, in response to determining that the screen activity of online shopping 236C is being performed in foreground window 112 (FIG. 2D) and identifying top topic “toy trucks” based on topic discovery of current screenshot 200 (FIG. 2E), an LLM may be implemented to automatically generate AI prompts 406C (FIG. 3C). As illustrated by FIGS. 4C-4D, AI prompts 406C output by the LLM include but are not limited to “What is the average cost of toy trucks right now?” “Do boys like toy trucks or toy cars better?” and “Summarize information about the main vendors for toy trucks as a table.” Additionally, as illustrated by FIG. 4D, the LLM has been implemented in a loop to automatically adapt to user input (see FIG. 3D). Accordingly, the LLM has further automatically completed the partial input 408 to generate adaptive AI prompt 410, “What is the best toy truck for boys right now?”

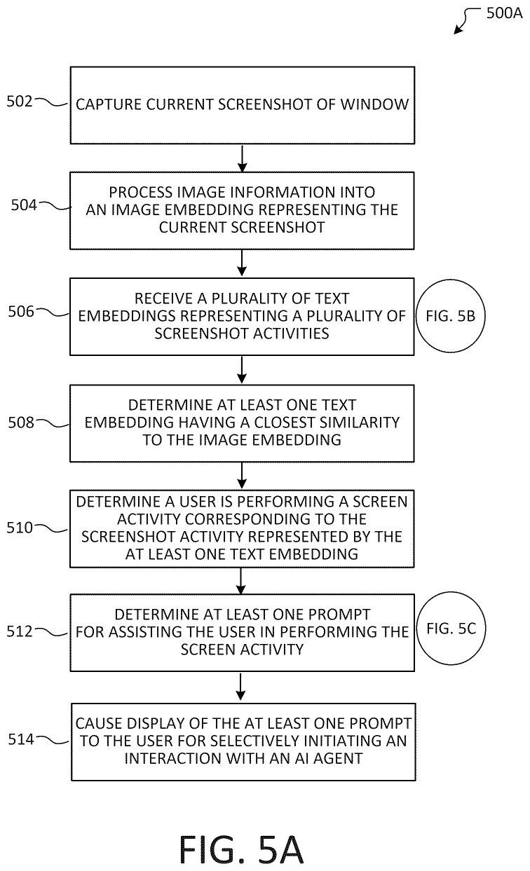

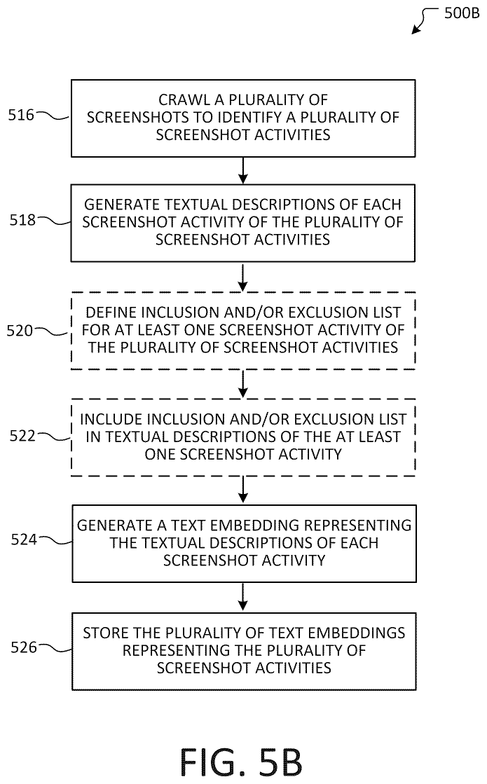

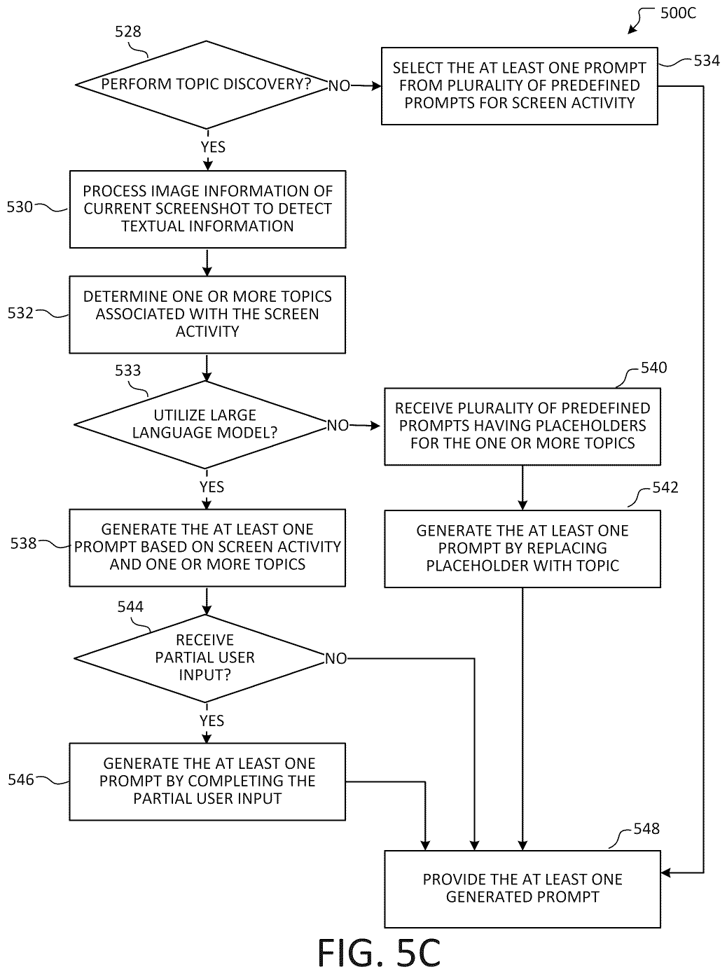

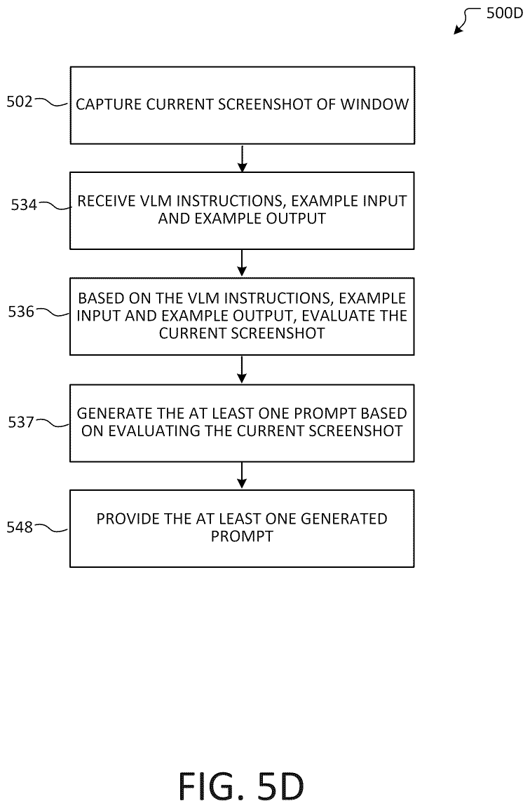

FIG. 5A illustrates an overview of an example method 500A for determining an AI prompt for assisting a user in performing a screen activity, according to aspects described herein.

As illustrated, method 500A begins at capture operation 502, where a current screenshot of a window associated with performing a screen activity may be captured. As noted above, a screen activity, for example, may include but is not limited to sending an email, web browsing, online shopping, listening to music, watching a video, attending a video conference, digital chatting, and the like. In some examples, screenshots of foreground windows may be captured; whereas in other examples, screenshots of foreground and background windows may be captured. A foreground window may be associated with a window in a forward position, which may overlap other windows but is not overlapped by other windows; whereas a background window is in a backward position overlapped by one or more other windows. In some aspects, a graphical user interface may include one or more foreground windows and zero, one, or more background windows.

At process operation 504, image information of the current screenshot may be processed into an image embedding (or image embeddings). For example, an image encoder may process the image information into the image embedding (e.g., image vector) representing the image content of the current screenshot. The image embedding (e.g., image vector) may include a plurality of dimensions uniquely representing the image content of the current screenshot. In aspects, the image encoder may be a machine learning (ML) model trained to process image content.

At receive operation 506, a plurality of text embeddings representing a plurality of screenshot activities are received. In aspects, a “screenshot activity” corresponds to a captured image of a “screen activity.” Using the examples above, a screenshot activity may include but is not limited to a captured image of sending an email, web browsing, online shopping, listening to music, watching a video, attending a video conference, digital chatting, and the like. As described further with respect to FIG. 5B, a text encoder may process textual descriptions for each of the plurality of screenshot activities to generate the plurality of text embeddings. Each text embedding (e.g., semantic vector) may include a plurality of dimensions uniquely representing the textual descriptions of a screenshot activity. In some examples, the text encoder may be an ML model trained to process text content.

At determine operation 508, the image embedding of the current screenshot is compared to each text embedding of the plurality of text embeddings to determine at least one text embedding having a closest similarity to the image embedding. For example, a zero-shot classifier may be utilized to calculate the similarity between the image vector representing the current screenshot and semantic vectors representing each of the plurality of screenshot activities. In aspects, a zero-shot classifier need not be retrained if more or fewer classes of screenshot activities are defined.

In some aspects, such a similarity calculation may be performed by a generative ML model. A generative ML model may be used to generate any of a variety of output types (and may thus be a multimodal generative model, in some examples). For example, the generative ML model may include a generative transformer model and/or a large language model (LLM), a generative image model, or the like. Example ML models include, but are not limited to, Megatron-Turing Natural Language Generation model (MT-NLG), Generative Pre-trained Transformer 3 (GPT-3), Generative Pre-trained Transformer 4 (GPT-4), BigScience BLOOM (Large Open-science Open-access Multilingual Language Model), DALL-E, DALL-E 2, Stable Diffusion, or Jukebox.

Further, according to aspects described herein, determining the at least one text embedding having a closest similarity to the image embedding may be performed without extracting text information from the current screenshot. That is, the methods and systems for determining a screen activity are performed on the image content of the current screenshot and are successful even when text associated with the current screenshot is blurred or otherwise illegible.

At determine operation 510, it may be determined that the user is performing a screen activity corresponding to the screenshot activity represented by the at least one text embedding. As noted above, the screen activity may include but is not limited to sending an email, web browsing, online shopping, listening to music, watching a video, attending a video conference, digital chatting, and the like.

At determine operation 512, a least one AI prompt for assisting the user in performing the screen activity may be determined. As described further with respect to FIG. 5C, the at least one AI prompt may be determined in various ways, including but not limited to selecting the at least one AI prompt from a plurality of predefined suggested AI prompts or generating the at least one AI prompt using a LLM, for example.

At cause operation 514, display of the at least one AI prompt may be caused. In aspects, the at least one AI prompt may be selectable by the user to initiate an interaction with an artificial intelligence (AI) agent for assisting performance of the screen activity.

In aspects, operations 502-514 may be performed in substantially real-time to automatically generate at least one AI prompt to aid the user in performing a screen activity. The operations may be performed locally and/or remotely to proactively provide well-formed AI prompts to aid the user in utilizing an AI agent, thereby improving the user experience while performing the activity.

FIG. 5B illustrates an overview of an example method 500B for generating text embeddings representing a plurality of screenshot activities, according to aspects described herein.

As illustrated, method 500B begins at crawl operation 516, where captured screenshots are crawled to identify a plurality of screenshot activities. For example, screen-based raw data and metadata may be collected and recorded every few seconds (e.g., 2 seconds) for one or more windows of a computing display. The captured screenshots may be processed by one or more ML models, e.g., a multimodal ML model, to extract and analyze text and/or images to identify the plurality of screenshot activities. As described above, a “screenshot activity” corresponds to a captured image of a “screen activity.” Thus, a screenshot activity may include but is not limited to a captured image of sending an email, web browsing, online shopping, listening to music, watching a video, attending a video conference, digital chatting, and the like.

At generate operation 518, textual descriptions of each screenshot activity of the plurality of screenshot activities may be generated. For example, for a screenshot activity of “writing an email,” textual descriptions may include without limitation, “writing an email,” “writing an email in gmail,” “writing an email in outlook,” “writing an email in yahoo,” and the like. In some aspects, one or more ML models, such as a LLM, may be utilized to generate the textual descriptions of each screenshot activity.

At optional define operation 520, an inclusion list and/or an exclusion list may be defined for at least one screenshot activity of the plurality of screenshot activities. For example, an inclusion list may entail one or more applications or one or more uniform resource locators (URLs) that may be associated with performing a screenshot activity; whereas an exclusion list may entail one or more applications or one or more URLs that are not associated with performing the screenshot activity. For example, for a screenshot activity of “writing an email,” an exclusion list may entail applications such as “Microsoft® Word®,” “Microsoft® Excel®,” and “Microsoft® PowerPoint®.” In contrast, an inclusion list may entail applications such as “Google® Chrome®,” “Microsoft® Edge®,” “Mozilla Firefox®,” “Microsoft® Outlook®,” and “Mozilla® Thunderbird®,” and/or URLs such as “mail.google.com,” “outlook.live.com,” and “mail.yahoo.com.” In aspects, an inclusion list and/or an exclusion list may be included in the textual descriptions of the screenshot activity.

At optional include operation 522, the inclusion list and/or exclusion list for the at least one screenshot activity may be included in the textual descriptions of the at least one screenshot activity. In some aspects, an exclusion list may better aid the zero-shot classifier in preventing false matches between text embeddings representing a screenshot activity and image embeddings representing a current screenshot than an inclusion list.

At generate operation 524, a text embedding of the textual descriptions for each screenshot activity may be generated. For example, a text encoder may process textual descriptions for each of the plurality of screenshot activities to generate the plurality of text embeddings. Each text embedding (e.g., semantic vector) may include a plurality of dimensions uniquely representing the textual descriptions of a screenshot activity. In some examples, the text encoder may be an ML model trained to process text content.

At store operation 526, the plurality of text embeddings representing the plurality of screenshot activities may be stored. In some aspects, operations 516-526 may not be performed at runtime. In this way, although a current screenshot may be processed in real-time, the plurality of text embeddings may be generated in advance and retrieved from storage to conserve time and resources and reduce latencies when automatically generating AI prompts for assisting the user in performing a current screen activity.

FIG. 5C illustrates an overview of an example method 500C for automatically generating AI prompts for assisting a user in performing a screen activity, according to aspects described herein.

As illustrated, method 500C begins at determination operation 528, where it is determined whether to perform topic discovery on the current screenshot. When topic discovery is performed, at process operation 530, the image information of the current screenshot is processed to detect textual information. In some aspects, the current screenshot may be processed by a local model running on the computing device. For example, the current screenshot may be processed using an optical character recognition (OCR) model to detect textual information. As should be appreciated, any model for detecting and/or extracting textual information from the current screenshot may be utilized, whether running locally or on a remote server system or cloud computing environment.

At determine operation 532, based on the textual information, one or more topics associated with the screen activity may be determined. For example, the textual information may be evaluated to extract terms, which in some cases may be scored for relevancy based on a number of times the terms appear, where the terms appear (e.g., header, subject line, body, etc.), and the like. Based on the scoring, a top subset of topics (e.g., top-K topics) associated with the screen activity may be determined. For example, for an online shopping activity, ranked terms such as “toy,” “car,” “truck,” “RC,” “boys,” may be associated with top-K topics including, “toy car,” “toy truck,” “toys for boys,” “remote control toys,” and the like.

When topic discovery is not performed, at select operation 534, the at least one AI prompt may be selected from a plurality of predefined AI prompts for the determined screen activity. As noted above, users often lack experience with properly forming AI prompts to an AI agent. In this case, a plurality of AI prompts may be predefined for each screen activity. In aspects, the plurality of AI prompts may be defined for actions that a user may not know how to do when performing the screen activity. Then, when it is determined that the user is performing the screen activity, the at least one AI prompt may be selected from the plurality of predefined AI prompts and provided to the user. For example, for sending an email activity, preformed AI prompts to an AI agent may include, “Set up an email signature,” “organize emails using labels or folders,” “scheduling an email to be sent later,” “create an email filter to manage incoming emails,” “enable ‘undo send’ feature,” and “set up an out-of-office auto-reply.” In some cases, a subset of the predetermined AI prompts may be provided to the user based on some criteria, e.g., context, AI prompts most often selected by users, etc.

At determination operation 533, it may be determined whether to utilize a large language model (LLM) to generate the at least one AI prompt. When it is determined to use a LLM, at generate operation 538, the at least one AI prompt may be generated based on the determined screen activity and the one or more topics determined at determine operation 532. In this case, as described above with reference to FIG. 3C, the LLM may be prompted with a chain-of-thought prompt followed by the determined screen activity and top-K topics. In this case, a well-formed AI prompt (or pill) may be generated which can adapt to the user's screen activity with more confidence, for example, than a predefined AI prompt. In some cases, running the LLM may cause latencies not experienced when selecting a predefined AI prompt. However, the benefits of generating a real-time AI prompt may outweigh latency concerns, which may also be improved by running a local LLM on a neural processing unit (NPU).

When it is determined not to use a LLM, at receive operation 540, a plurality of predefined AI prompts having topic placeholders may be received. In this case, the plurality of AI prompts may be predefined for each screen activity but may be customizable based on the one or more topics. Using the example of sending an email activity, preformed AI prompts including topic placeholders may include, “set up an email subject line regarding <TOPIC>,” “organize emails using labels or folders for <TOPIC>,” “schedule an email regarding <TOPIC> to be sent later,” “create an email filter for <TOPIC> to manage incoming emails,” “enable ‘undo send’ feature for <TOPIC>,” and “set up a distribution group related to <TOPIC>.”

At generate operation 542, the top-K topics (or a top topic of the top-K topics) is used to replace the topic placeholder in the predefined AI prompt to generate the at least one AI prompt. In this way, the at least one AI prompt is more specific to the screen activity at hand, while also enabling responsive, real-time AI support to the user. In some examples, replacing the topic placeholder in the predefined AI prompt with the top topic may result in a non-sensical AI prompt. To avoid a poor user experience, the generated at least one AI prompt may be examined for semantic and grammatical coherence before the method advances to provide operation 548.

At determination operation 544, it is determined whether a partial user input is received. When a partial user input is received, at generate operation 546, an LLM may be used to generate the at least one AI prompt by completing the partial user input. In this case, as described above with reference to FIG. 3D, the LLM may be prompted with a chain-of-thought prompt followed by the determined screen activity and top-K topics. In addition, the LLM may be run in a loop to auto-complete the partial user input. In this way, the at least one AI prompt is adaptive to the user's input. However, in some cases, running the LLM may cause latencies not experienced when selecting or customizing a predefined AI prompt. Even so, the benefits of generating an adaptive, real-time AI prompt may outweigh latency concerns, which may also be improved by running a local LLM on a neural processing unit (NPU).

At provide operation 548, the at least one AI prompt may be provided to the user. For example, display of the at least one AI prompt may be caused at operation 514. In aspects, the at least one AI prompt may be selectable for initiating an interaction with an AI agent to aid in performing the screen activity.

FIG. 5D illustrates an overview of an example method 500D for automatically generating AI prompts end-to-end for assisting a user in performing a screen activity, according to aspects described herein.

As illustrated, method 500D begins at capture operation 502, where a current screenshot of a window associated with performing a screen activity may be captured. As noted above, a screen activity, for example, may include but is not limited to sending an email, web browsing, online shopping, listening to music, watching a video, attending a video conference, digital chatting, and the like. In some examples, screenshots of foreground windows may be captured; whereas in other examples, screenshots of foreground and background windows may be captured. A foreground window may be associated with a window in a forward position, which may overlap other windows but is not overlapped by other windows; whereas a background window is in a backward position overlapped by one or more other windows. In some aspects, a graphical user interface may include one or more foreground windows and zero, one, or more background windows.

At receive operation 534, visual-language model (VLM) instructions, an example screenshot input, and example AI prompt output may be received. For example, VLM instructions may include a chain-of-thought instruction such as, “You are a helpful AI assistant to a user who is performing an activity on a computer screen. Your goal is to output a sentence that can proactively anticipate questions that a user might ask about the current screen. We will provide you with a sample screenshot input and prompt outputs.” See, e.g. FIG. 3E, reference 308C. The sample screenshot input may include a news screenshot related to oil and gas (see, e.g., FIG. 3E, reference 320) and example AI prompt output may include, “How will the crude oil price effect gas prices?”; “What is the price of gas right now?”; “Summarize information about the main players in the global shipping industry as a table” (see, e.g., FIG. 3E, reference 312).

At evaluate operation 536, based on the VLM instructions, example screenshot input and example AI prompt output, the current screenshot may be evaluated by a VLM. In some examples, the VLM may be a multimodal visual-language model that is able to extract and process text and images from the current screenshot.

At generate operation 537, based on evaluating the current screenshot, the VLM is able to directly generate the at least one AI prompt. For example, the at least one AI prompt may include “What is the average cost of toy trucks right now?” “Do boys like toy trucks or toy cars better?” and “Summarize information about the main vendors for toy trucks as a table” (see, e.g., FIG. 3E, reference 318A.

At provide operation 548 (see FIG. 5C), the at least one AI prompt may be provided to the user. For example, display of the at least one AI prompt may be caused at operation 514. In aspects, the at least one AI prompt may be selectable for initiating an interaction with an AI agent to aid in performing the screen activity.

As should be appreciated, operations 502-548 are described for purposes of illustrating the present methods and systems and are not intended to limit the disclosure to a particular sequence of steps, e.g., operations may be performed in a different order and more or fewer operations may be performed without departing from the present disclosure.

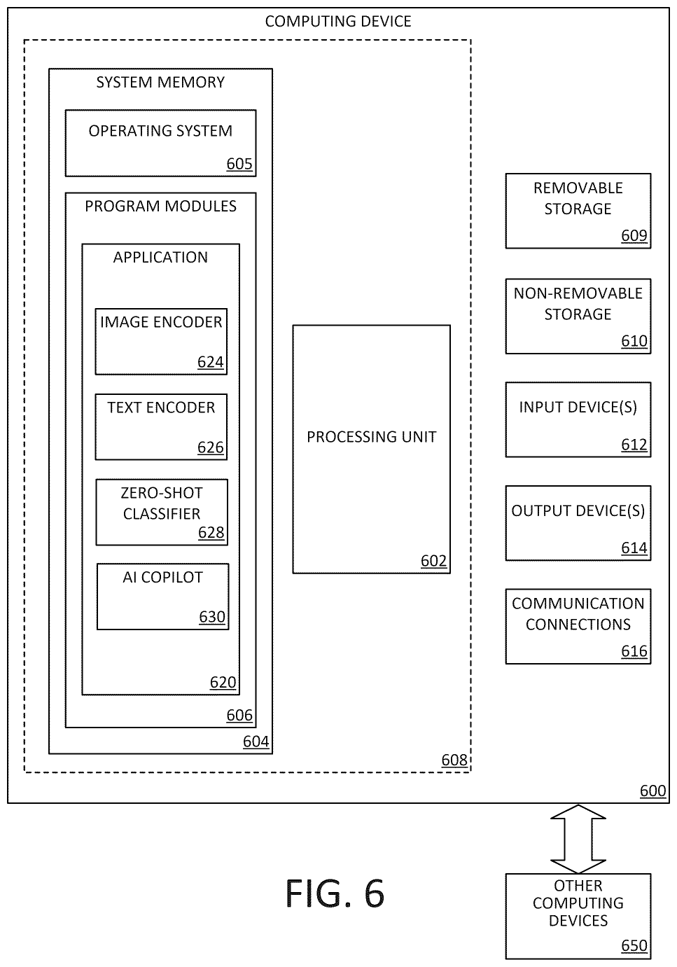

FIGS. 6-8 and the associated descriptions provide a discussion of a variety of operating environments in which aspects of the disclosure may be practiced. However, the devices and systems illustrated and discussed with respect to FIGS. 6-8 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may be suitable for the computing devices described above, e.g., with respect to FIG. 1. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. As examples, system memory 604 may store program modules 606, including application 620. Application 620 may further include image encoder 624, text encoder 626, zero-shot classifier 628, and AI copilot 630. The operating system 605, for example, may be suitable for controlling the operation of the computing device 600.

Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules 606 and data files may be stored in the system memory 604. While executing on the processing unit 602, the program modules 606 (e.g., application 620) may perform processes including, but not limited to, the aspects, as described herein.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

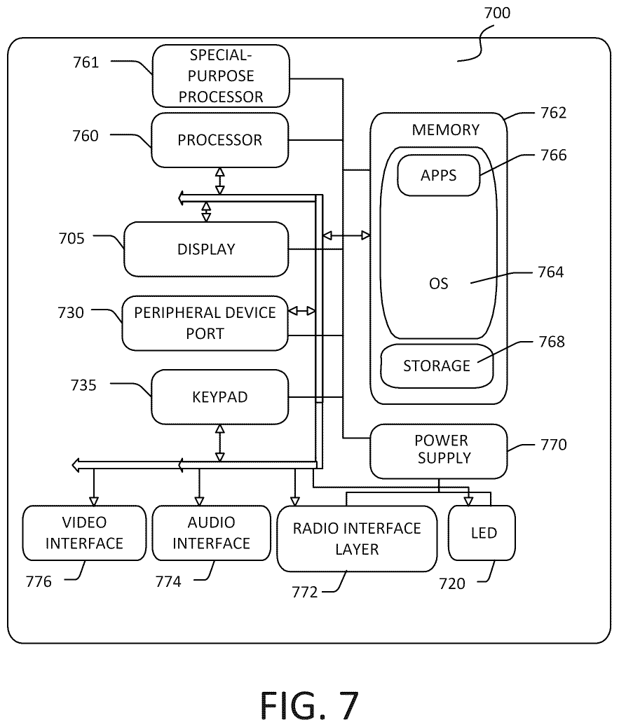

FIG. 7 illustrates a system 700 that may, for example, be a mobile computing device, such as a mobile telephone, a smart phone, wearable computer (such as a smart watch), a tablet computer, a laptop computer, and the like, with which embodiments of the disclosure may be practiced. In one embodiment, the system 700 is implemented as a “smart phone” capable of running one or more applications (e.g., browser, e-mail, calendaring, contact managers, messaging clients, games, and media clients/players). In some aspects, the system 700 is integrated as a computing device, such as an integrated personal digital assistant (PDA) and wireless phone.

In a basic configuration, such a mobile computing device is a handheld computer having both input elements and output elements. The system 700 typically includes a display 705 and one or more input buttons that allow the user to enter information into the system 700. The display 705 may also function as an input device (e.g., a touch screen display).

If included, an optional side input element allows further user input. For example, the side input element may be a rotary switch, a button, or any other type of manual input element. In alternative aspects, system 700 may incorporate more or less input elements. For example, the display 705 may not be a touch screen in some embodiments. In another example, an optional keypad 735 may also be included, which may be a physical keypad or a “soft” keypad generated on the touch screen display.

In various embodiments, the output elements include the display 705 for showing a graphical user interface (GUI), a visual indicator (e.g., a light emitting diode 720), and/or an audio transducer 725 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 700 also includes a non-volatile storage area 768 within the memory 762. The non-volatile storage area 768 may be used to store persistent information that should not be lost if the system 700 is powered down. The application programs 766 may use and store information in the non-volatile storage area 768, such as e-mail or other messages used by an e-mail application, and the like. A synchronization application (not shown) also resides on the system 700 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the system 700 described herein.

The system 700 has a power supply 770, which may be implemented as one or more batteries. The power supply 770 might further include an external power source, such as an AC adapter or a powered docking cradle that supplements or recharges the batteries.

The system 700 may also include a radio interface layer 772 that performs the function of transmitting and receiving radio frequency communications. The radio interface layer 772 facilitates wireless connectivity between the system 700 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 700 may further include a video interface 776 that enables an operation of an on-board camera 730 to record still images, video stream, and the like.

It will be appreciated that system 700 may have additional features or functionality. For example, system 700 may also include additional data storage devices (removable and/or non-removable) such as, magnetic disks, optical disks, or tape. Such additional storage is illustrated in FIG. 7 by the non-volatile storage area 768.

Data/information generated or captured and stored via the system 700 may be stored locally, as described above, or the data may be stored on any number of storage media that may be accessed by the device via the radio interface layer 772 or via a wired connection between the system 700 and a separate computing device associated with the system 700, for example, a server computer in a distributed computing network, such as the Internet. As should be appreciated, such data/information may be accessed via the radio interface layer 772 or via a distributed computing network. Similarly, such data/information may be readily transferred between computing devices for storage and use according to any of a variety of data/information transfer and storage means, including electronic mail and collaborative data/information sharing systems.

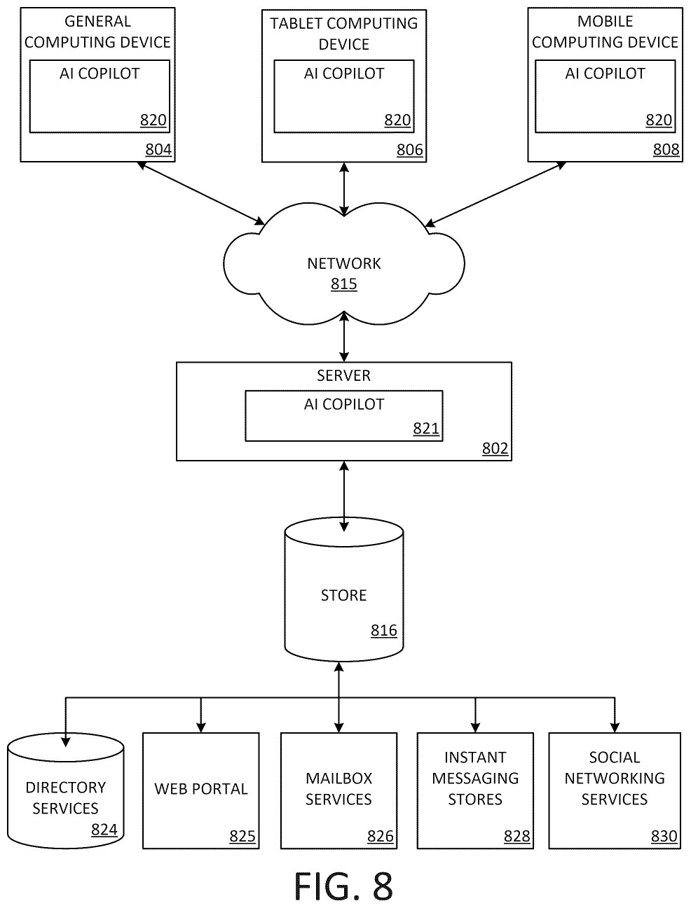

FIG. 8 illustrates one aspect of the architecture of a system for processing data received at a computing system from a remote source, such as a personal computer 804, tablet computing device 806, or mobile computing device 808, as described above. Content displayed at server device 802 may be stored in different communication channels or other storage types. For example, various documents may be stored using a directory service 824, a web portal 825, a mailbox service 826, an instant messaging store 828, or a social networking site 830.

An AI copilot 820 (e.g., similar to application 620) may be employed by a client that communicates with server device 802. Additionally, or alternatively, AI copilot 821 may be employed by server device 802. The server device 802 may provide data to and from a client computing device such as a personal computer 804, a tablet computing device 806 and/or a mobile computing device 808 (e.g., a smart phone) through a network 815. By way of example, the computer system described above may be embodied in a personal computer 804, a tablet computing device 806 and/or a mobile computing device 808 (e.g., a smart phone). Any of these examples of the computing devices may obtain content from the store 816, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

In aspects, a system is provided. The system includes at least one processor and memory storing instructions that, when executed by the at least one processor, cause the system to perform a set of operations. The set of operations include capturing a current screenshot of a window on a computer display and processing image information associated with the current screenshot into an image embedding. The set of operations further including receiving a plurality of text embeddings representing a plurality of screenshot activities and determining at least one text embedding having a closest similarity to the image embedding, where the at least one text embedding represents a screenshot activity of the plurality of screenshot activities. Additionally, the set of operations include determining a user is performing a screen activity corresponding to the screenshot activity represented by the at least one text embedding and, based on the screen activity, determining at least one prompt for assisting the user in performing the screen activity.

In additional aspects of the system above, the set of operations further include processing the image information associated with the current screenshot to detect textual information and, based on the textual information, determining one or more topics associated with the screen activity. Additionally, the set of operations include, based on the one or more topics, determining the at least one prompt for assisting the user in performing the screen activity. Further, where determining the at least one prompt includes receiving a plurality of predefined prompts for the screen activity, wherein each predefined prompt includes a placeholder and generating the at least one prompt by replacing the placeholder with a topic of the one or more topics. Yet further, where determining the at least one prompt includes generating the at least one prompt by querying a large language model (LLM) based on the screen activity and the one or more topics. Still further, where determining the at least one prompt includes receiving partial user input and generating the at least one prompt by querying the LLM in a loop to complete the partial user input. Additionally, the set of operations including causing display of the at least one prompt to the user for selectively initiating an interaction with an AI agent. The system yet further, where determining the at least one prompt includes selecting the at least one prompt from a plurality of predefined prompts for the screen activity. Additionally, the system where the image information of the current screenshot is processed using one or more machine learning (ML) models. Still further, the system where determining the at least one text embedding having the closest similarity to the image embedding is performed using a multimodal ML model.

In further aspects, a method of automatically determining at least one prompt for assisting a user in performing a screen activity is provided. The method including capturing a current screenshot of a window on a computing display and processing image information associated with the current screenshot into an image embedding. Additionally, the method including receiving a plurality of text embeddings representing a plurality of screenshot activities and determining at least one text embedding having a closest similarity to the image embedding, where the at least one text embedding represents a screenshot activity of the plurality of screenshot activities. The method further including determining a user is performing the screen activity corresponding to the screenshot activity represented by the at least one text embedding and processing the image information associated with the current screenshot to determine one or more topics associated with the screen activity. Based on the screen activity and the one or more topics, the method including automatically determining the at least one prompt for assisting the user in performing the screen activity.

In additional aspects of the method above, where automatically determining the at least one prompt further includes receiving a plurality of predefined prompts for the screen activity, wherein each predefined prompt includes a placeholder and generating the at least one prompt by replacing the placeholder with a topic of the one or more topics. Additionally, where automatically determining the at least one prompt includes generating the at least one prompt by querying a large language model (LLM) based on the screen activity and the one or more topics. In further aspects of the method, where determining the at least one prompt includes receiving partial user input and generating the at least one prompt by querying the LLM in a loop to complete the partial user input. In still further aspects, the method including causing display of the at least one prompt to the user for selectively initiating an interaction with an AI agent. Additionally, where determining the at least one text embedding having the closest similarity to the image embedding is performed using a multimodal ML model. Still further, where processing the image information associated with the current screenshot includes processing the image information associated with the current screenshot to detect textual information and based on the textual information, determining the one or more topics associated with the screen activity.

In yet further aspects, a method of automatically determining at least one prompt for assisting a user in performing a screen activity is provided. The method including capturing a current screenshot of a window on a computer display. Additionally, the method including receiving a VLM instruction to evaluate a screenshot and generate at least one prompt and receiving an example screenshot and one or more example prompts generated based on the example screenshot. The method further including evaluating the current screenshot, wherein the evaluating includes at least one of processing text or images associated with the current screenshot and, based on the evaluating the current screenshot, determining at least one prompt for assisting the user. Additionally, the method including causing display of the at least one prompt to the user for selectively initiating an interaction with an AI agent. In further aspects of the method, evaluating the current screenshot to determine the user is performing a screen activity. In still further aspects, where the at least one prompt is for assisting the user in performing the screen activity.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations, the set of operations comprising:
capturing a current screenshot of a window on a computer display;
processing image information associated with the current screenshot into an image embedding;
receiving a plurality of text embeddings representing a plurality of screenshot activities;
determining at least one text embedding having a closest similarity to the image embedding, wherein the at least one text embedding represents a screenshot activity of the plurality of screenshot activities;
determining a user is performing a screen activity corresponding to the screenshot activity represented by the at least one text embedding; and
based on the screen activity, determining at least one prompt for assisting the user in performing the screen activity.

2. The system of claim 1, the set of operations further comprising:
processing the image information associated with the current screenshot to detect textual information; and
based on the textual information, determining one or more topics associated with the screen activity.

3. The system of claim 2, the set of operations further comprising:
based on the one or more topics, determining the at least one prompt for assisting the user in performing the screen activity.

4. The system of claim 3, wherein determining the at least one prompt further comprises:
receiving a plurality of predefined prompts for the screen activity, wherein each predefined prompt includes a placeholder; and
generating the at least one prompt by replacing the placeholder with a topic of the one or more topics.

5. The system of claim 3, wherein determining the at least one prompt further comprises:
generating the at least one prompt by querying a large language model (LLM) based on the screen activity and the one or more topics.

6. The system of claim 5, wherein determining the at least one prompt further comprises:
receiving partial user input; and
generating the at least one prompt by querying the LLM in a loop to complete the partial user input.

7. The system of claim 1, the set of operations further comprising:
causing display of the at least one prompt to the user for selectively initiating an interaction with an AI agent.

8. The system of claim 1, wherein determining the at least one prompt includes selecting the at least one prompt from a plurality of predefined prompts for the screen activity.

9. The system of claim 1, wherein the image information of the current screenshot is processed using one or more machine learning (ML) models.

10. The system of claim 1, wherein determining the at least one text embedding having the closest similarity to the image embedding is performed using a multimodal ML model.

11. A method of automatically determining at least one prompt for assisting a user in performing a screen activity, comprising:
capturing a current screenshot of a window on a computing display;
processing image information associated with the current screenshot into an image embedding;
receiving a plurality of text embeddings representing a plurality of screenshot activities;
determining at least one text embedding having a closest similarity to the image embedding, wherein the at least one text embedding represents a screenshot activity of the plurality of screenshot activities;
determining a user is performing the screen activity corresponding to the screenshot activity represented by the at least one text embedding;
processing the image information associated with the current screenshot to determine one or more topics associated with the screen activity; and
based on the screen activity and the one or more topics, automatically determining the at least one prompt for assisting the user in performing the screen activity.

12. The method of claim 11, wherein automatically determining the at least one prompt further comprises:
receiving a plurality of predefined prompts for the screen activity, wherein each predefined prompt includes a placeholder; and
generating the at least one prompt by replacing the placeholder with a topic of the one or more topics.

13. The method of claim 11, wherein automatically determining the at least one prompt further comprises:
generating the at least one prompt by querying a large language model (LLM) based on the screen activity and the one or more topics.

14. The method of claim 13, wherein determining the at least one prompt further comprises:
receiving partial user input; and
generating the at least one prompt by querying the LLM in a loop to complete the partial user input.

15. The method of claim 11, further comprising:
causing display of the at least one prompt to the user for selectively initiating an interaction with an AI agent.

16. The method of claim 11, wherein determining the at least one text embedding having the closest similarity to the image embedding is performed using a multimodal ML model.

17. The method of claim 11, wherein processing the image information associated with the current screenshot further comprises:
processing the image information associated with the current screenshot to detect textual information; and
based on the textual information, determining the one or more topics associated with the screen activity.

18. A method of automatically determining at least one prompt for assisting a user in performing a screen activity, comprising:
capturing a current screenshot of a window on a computer display;
receiving a visual-language model (VLM) instruction to evaluate a screenshot and generate at least one prompt;
receiving an example screenshot and one or more example prompts generated based on the example screenshot;
evaluating the current screenshot, wherein the evaluating includes at least one of processing text or images associated with the current screenshot;
based on the evaluating the current screenshot, determining at least one prompt for assisting the user, and
causing display of the at least one prompt to the user for selectively initiating an interaction with an AI agent.

19. The method of claim 18, further comprising:
evaluating the current screenshot to determine the user is performing a screen activity.

20. The method of claim 19, wherein the at least one prompt is for assisting the user in performing the screen activity.
